(19) United States
(12) Patent Application Publication
(10) Pub. No.: US 2023/0243727 A1
(43) Pub. Date: Aug. 3, 2023

(54) METHOD OF DETERMINING WHETHER A HOST HAS AN INFECTION

(71) Applicant: HYPATIA SOLUTIONS LTD, Buckingham (GB)

(72) Inventor: Mark Ralph BAKER, Buckingham (GB)

(21) Appl. No.: 17/997,225

(22) PCT Filed: Apr. 30, 2021
(86) PCT No.: PCT/GB2021/051052

§ 371 Date: Oct. 26, 2022

(30) Foreign Application Priority Data
Apr. 30, 2020 (GB) 2006374.9
May 6, 2020 (GB) 2006742.7

(51) Int. Cl. G01N 15/06; G01N 15/10; G01N 15/00; G01N 15/14

(52) U.S. Cl. CPC G01N 15/06; G01N 2015/1006; G01N 2015/008; G01N 2015/1402; G01N 2015/1486

(57) ABSTRACT

The invention relates to a method of determining whether a host has an infection. The method comprises obtaining measured values comprising a number of leukocytes and a number of a first type of leukocytes in a blood sample from the host, and comparing the measured values with one or more stored threshold value(s) to determine whether the host has said infection.

### TECHNICAL FIELD

The present disclosure relates to a method of determining whether a host has an infection, particularly, but not exclusively, to a method of determining whether a host has an infection using measured values including the number of leukocytes and a number of a type of leukocyte.

### BACKGROUND

An infection is caused by a microorganism such as a bacteria or virus entering the host (human or animal) and multiplying.

In some types of infection, for example, infection by the virus SARS-CoV2 which causes the illness Covid-19, a host may be infectious without experiencing symptoms themselves or before symptoms occur. Furthermore, there is often an initial period during which the host is infectious, but infection cannot yet be identified by available tests. Thus, during this initial infection period an infected host may generate a negative test for the infection but may still infect others with the virus. On a large scale, this can lead to epidemics or pandemics which have widespread health, social and economic consequences, such as that experienced around the world recently due to the spread of SARS-CoV2. Furthermore, currently available tests for infections often require specialist facilities, practitioners and/or reagents, which are both expensive and limited in capacity.

There is therefore a need for a method that can effectively and economically diagnose infection of a host at an earlier stage in the infection.

### SUMMARY OF THE INVENTION

There is provided a method of determining whether a host has an infection, the method comprising: obtaining measured values comprising a number of leukocytes and a number of a first type of leukocytes in a blood sample from the host, and comparing the measured values with one or more stored threshold value(s) to determine whether the host has said infection.

This method enables predicting or diagnosing specific infections by determining whether the host has that infection using the measured values and a threshold value. Changes in the numbers of some types of blood cells occur in the early stages of an infection, often without the infection being apparent to the host (human or animal). This method utilises these early changes in the host to enable the infection to be detected earlier than is possible with available infection tests, such as antigen tests.

In this application, the measured and/or threshold values may also be referred to as predictive and diagnostic values. The infection is a specified infection. In other words, the method determines the presence of a particular, or specific infection in the host and not merely the presence of any infection.

The host may be a human being. The infection may be infection by the virus SARS-CoV2. In this case, the method can predict and diagnose the infection of human beings with the virus known at the time of application as SARS-CoV2, which causes the illness known at the time of application as Covid-19. SARS-CoV2 is recognized as highly infectious and causes serious illness and death in some people and can be infectious without symptoms being present or before symptoms occur. It is therefore useful to identify infectious people in order to prevent them from carrying and spreading the infection to others.

However, tests in use at the time of application do not detect SARS-CoV2 in the early stages of the host person being infectious, resulting initially in the spreading of the infection and then in the need to keep members of populations isolated from each other to avoid unidentified hosts spreading the infection further; this isolation then causes other health and economic problems. Furthermore, tests for SARS-CoV2 that are in use at the time of application not only fail to identify early-stage infections, but require specialist facilities and reagents, which are relatively expensive and limited in capacity.

To overcome these problems, the method of the present invention can be used to identify SARS-CoV2 infection earlier than other methods in use at the time of application, by analysing standard full blood count (CBC) test results of people in the general population and/or people who are most likely to be exposed to the virus. In addition to identifying infection earlier, the blood tests used in the present invention have lower cost and greater capacity than other SARS-CoV2 tests in use at the time of application.

Obtaining the measured values may comprise receiving blood test results, for example, CBC test results for the host and extracting the measured values from the blood test results. Alternatively, obtaining the measured values may comprise receiving the measured values. The CBC test results and/or measured values may be obtained from a storage location which may be on a server, a database, a blood testing device, a user device such as a smartphone, laptop or tablet or may be obtained from a user input. In some embodiments a blood test other than a CBC may be used. Any blood test that includes the measured values of the method may be used. Obtaining the measured values may comprise performing the blood test on the blood sample of the host, for example CBC test and extracting the measured values from the results of the blood test.

The method involves analysing the numbers of leukocytes (white blood cells) and specific leukocyte cell types that are given in standard full blood count (CBC) test results, in such a way as to identify not just the presence of infection, but the presence of a specific infection. We call this method ‘leukocyte fingerprinting’. The standard full blood count (CBC) test is well developed and capacity for performing these tests is high, so by using data collected in a CBC test, the method of determination of infection may be deployed quickly, efficiently and inexpensively to very large amounts of people which is very important during an epidemic or pandemic.

The first type of leukocytes may be a type of leukocyte which is measured in a full blood count (CBC) test. The first type of leukocytes may be monocytes or eosinophils. The measured values may further comprise a number of a second type of leukocytes and optionally a number of a third type and/or additional types of leukocytes. The second type of leukocytes may be type of leukocyte which is measured in a full blood count (CBC) test, for example, neutrophils, eosinophils, lymphocytes or monocytes. The measured values may comprise, number of leukocytes, number of monocytes and number of eosinophils. The measured values need not comprise a number of leukocytes and/or a first number of a type of leukocytes. The measured values may comprise one or more blood cell types or platelets and/or blood born changes or infections, for example, the presence of plasmodium, for example malaria, or leukaemia cells. The blood cell types may comprise total number of leukocytes, number of neutrophils, eosinophils, basophils, monocytes, lymphocytes, T cells, and/or B cells.

The method may further comprise informing a user, for example the host and/or a medical practitioner, of the determination of whether the host has the infection. For example, informing a user may comprise displaying the determination on a screen of a user device such as a laptop, smartphone, tablet or blood testing device, or sending a communication such as an email, SMS, or other electronic message to the user.

Comparing the measured values with a one or more stored threshold value(s) value to determine whether the host has the infection may comprise performing a calculation on the measured values and comparing the result of the calculation with the threshold. Comparing the measured values and/or calculation result with the threshold may comprise determining whether the measured values and/or calculation result is larger than the threshold.

The calculation may be a calculation comparing the number of monocytes, M relative to the number of leukocytes, L. The calculation may be the ratio of number of monocytes to number of leukocytes, M/L=alpha, α. The calculation may be the number of leukocytes minus the number of monocytes, L−M=beta, β.

The calculation may be a calculation comparing the number of monocytes, M relative to the number of leukocytes, L and eosinophils, E. The calculation may be the ratio of number of monocytes to number of leukocytes plus the number of eosinophils, M/(L+E)=gamma, γ.

The calculation may be the number of leukocytes plus the number of eosinophils minus the number of monocytes, L+E−M=delta, δ.

A plurality of separate calculations may be performed on the measured values. Each calculation result may be compared with a respective threshold. Measured values may be compared with respective thresholds. When a plurality of comparisons are made, a determination that a host is infected may be made based on any one or more of the comparisons determining that the host is infected. Alternatively, a determination that a host is infected may be made based on all, or a selection of the comparisons determining that the host is infected. Where more than one calculation and comparison with a respective threshold result in the same determination of whether a host is infected, confidence in the determination may be increased.

The measured values may comprise a number of leukocytes, number of eosinophils, number of neutrophils and number of lymphocytes. A calculation may be the number of leukocytes minus the number of neutrophils (λ=L−N). A calculation may be the number of leukocytes minus the number of eosinophils (κ=L−E). Comparing measured values with one or more stored thresholds may comprise comparing λ, κ and each of the measured values with a respective threshold.

The infection threshold μ (mu) for the κ calculation may be 7.00 10\hat{ }9/L. If the value is greater than μ (mu) then the result is positive. The infection threshold ν (nu) for the λ calculation may be 2.02 10\hat{ }9/L. If the value is less than that then the result is positive. The infection threshold ξ (xi) for number of eosinophils may be 0.09 10\hat{ }9/L. If the value is less than that then the result is positive. The infection threshold o (omicron) for number of lymphocytes may be 1.64 10\hat{ }9/L. If the value is less than that then the result is positive. The infection threshold ρ (ro) for number of neutrophils may be 5.07 10\hat{ }9/L. If the value is greater than that then the result is positive. The infection threshold σ (sigma) for number of leukocytes may be 8.00 10\hat{ }9/L. If the value is greater than that then the result is positive.

When one or more of the comparisons give a positive result, the determination that the host is infected may be made. Using the thresholds μ, ν, ξ, o, ρ and σ, the sensitivity may be 97.29% and the specificity may be 67.95%.

The infection threshold μ (mu) for the κ calculation may be between 3.50 10\hat{ }9/L to 10.50 10\hat{ }9/L, optionally, between 6.30 10\hat{ }9/L to 7.70 10\hat{ }9/L, optionally, 7.00 10\hat{ }9/L. If the value is greater than μ (mu) then the result is positive. The infection threshold ν (nu) for the λ calculation may be between 1.01 10\hat{ }9/L to 3.03 10\hat{ }9/L, optionally, between 1.818 10\hat{ }9/L to 2.222 10\hat{ }9/L, optionally, 2.02 10\hat{ }9/L. If the value is less than that then the result is positive. The infection threshold ξ (xi) for number of eosinophils may be between 0.045 10\hat{ }9/L to 0.135 10\hat{ }9/L, optionally, between 0.081 10\hat{ }9/L to 0.99 10\hat{ }9/L. optionally, 0.09 10\hat{ }9/L. If the value is less than that then the result is positive. The infection threshold o (omicron) for number of lymphocytes may be between 0.82 10\hat{ }9/L to 2.46 10\hat{ }9/L, optionally, between 1.476 10\hat{ }9/L to 1.804 10\hat{ }9/L, optionally, 1.64 10\hat{ }9/L. If the value is less than that then the result is positive. The infection threshold ρ (ro) for number of neutrophils may be between 2.535 10\hat{ }9/L to 7.605 10\hat{ }9/L, optionally, between 4.563 10\hat{ }9/L to 5.577 10\hat{ }9/L, optionally, 5.07 10\hat{ }9/L. If the value is greater than that then the result is positive. The infection threshold σ (sigma) for number of leukocytes may be between 4.00 10\hat{ }9/L to 12.00 10\hat{ }9/L, optionally, between 7.2 10\hat{ }9/L to 8.80 10\hat{ }9/L, optionally, 8.00 10\hat{ }9/L. If the value is greater than that then the result is positive.

When one or more of the comparisons give a positive result, the determination that the host is infected may be made. Using the thresholds μ, ν, ξ, o, ρ and σ, the sensitivity may be between 96.5% and 98.5%, optionally, 97.29% and the specificity may be between 66.00% to 69.00%, optionally, 67.95%.

A calculation may be the number of leukocytes minus the number of neutrophils (λ=L−N). Comparing measured values with one or more stored thresholds may comprise comparing each of λ, and the number of eosinophils and the number of lymphocytes with a respective threshold.

The infection threshold υ (upsilon) for the λ calculation may be 1.50 10\hat{ }9/L. If the value is less than that then the result is positive. The infection threshold φ (phi) for number of eosinophils may be 0.03 10\hat{ }9/L. If the value is less than that then the result is positive. The infection threshold χ (chi) for number of lymphocytes may be 1.10 10\hat{ }9/L. If the value is less than that then the result is positive.

When one or more of the comparisons give a positive result, the determination that the host is infected may be made. When the thresholds υ, φ and χ are used, the sensitivity of the determination of whether the host is infected may be 84.90% and the specificity may be 96.40%.

The infection threshold υ (upsilon) for the λ calculation may be between 0.75 10\hat{ }9/L to 2.25 10\hat{ }9/L, optionally, between 1.35 10\hat{ }9/L to 1.65 10\hat{ }9/L, optionally, 1.50 10\hat{ }9/L. If the value is less than that then the result is positive. The infection threshold φ (phi) for number of eosinophils may be 0.015 10\hat{ }9/L to 0.045 10\hat{ }9/L, optionally, between 0.027 10\hat{ }9/L to 0.033 10\hat{ }9/L, optionally, 0.03 10\hat{ }9/L. If the value is less than that then the result is positive. The infection threshold χ (chi) for number of lymphocytes may be between 0.55 10\hat{ }9/L to 1.65 10\hat{ }9/L, optionally, between 0.99 10\hat{ }9/L to 1.21 10\hat{ }9/L, optionally, 1.10 10\hat{ }9/L. If the value is less than that then the result is positive.

When one or more of the comparisons give a positive result, the determination that the host is infected may be made. When the thresholds υ, φ and χ are used, the sensitivity of the determination of whether the host is infected may be between 83% to 87%, optionally, 84.90% and the specificity may be between 95% to 98%, optionally, 96.40%.

Calculations, values, results and thresholds discussed herein may comprise standardised and/or normalised, and/or absolute data. Where values are stated, it is to be understood that equivalent values in data having undergone different standardisation and/or normalisation and/or other data processing techniques are equally applicable. Data may be standardised e.g. over historical values from a particular laboratory and/or set of patients and/or measuring devices.

For calculation β, where the data has been standardized, to have a mean of 0 and a standard deviation of 1, the infection threshold ζ (zeta) may be between −2.09 and −1.05, for example, −1.445. The infection threshold ζ (zeta) may be −1.445, when all age groups are taken together. This threshold distinguishes patients who will later test positive for SARS-CoV2 using the SARS-CoV-2 rt-PCR test. The value of ζ may be adjusted between −2.09 and −1.05 to adjust the ratio of false negatives to false positives in the test. In the test data sets initially used to determine this threshold, p value is 1.2e-11.

The difference between infected and non-infected people in calculation results α, β, γ and δ is typically apparent before symptoms occur, and before existing tests can distinguish between patients who would later test SARS-CoV2 positive and those who would test SARS-CoV2 negative. The calculations and/or thresholds used are specific to a particular infection, so by adjusting the calculation and/or threshold, the method may be adapted to another infection.

Predictive and diagnostic values may be calculated from the numbers of leukocytes, monocytes and eosinophils that are given in the standard full blood count (CBC) test results. Threshold predictive and diagnostic values may be obtained, along with statistical measures that indicate the proportions of false positives and false negatives that will be obtained for these threshold predictive and diagnostic values.

Comparing the measured values with one or more stored threshold value(s) to determine whether the host has said infection may further comprise selecting the threshold value from a series of threshold values based on one or more factors such as the age and/or sex of the host, genetic factors and/or environmental factors. Comparing the measured values with one or more stored threshold value(s) to determine whether the host has said infection may further comprise selecting a calculation based on factors such as age and/or sex of the host, genetic factors and/or environmental factors. Factors such as age and sex of the host may affect the threshold values and/or calculations which best distinguish between hosts with the infection and hosts who are not infected. By selecting a calculation and/or threshold value based on these factors the result of the determination may be more accurate.

There is further provided a method of calculating a threshold value for use in determining whether a host has an infection, the method comprising: obtaining measured values comprising a number of leukocytes and a number of a first type of leukocytes in a blood sample from each of a plurality of subjects, obtaining an infection status for each of the subjects, analysing the measured values and infection statuses to determine the threshold value.

Obtaining the measured values for each subject may be done in the ways described above for the measured values of the host. The method may be carried out separately for groups of subjects with factors in common. For example, the method may be carried out for subjects of a particular age range and/or a sex. The calculation and/or threshold found using subjects having one or more factors may be used in methods of determining whether a host with the same factors has an infection.

The first type of leukocytes may be a type of leukocyte which is measured in a full blood count (CBC) test. The first type of leukocytes may be monocytes or eosinophils. The measured values may further comprise a number of a second type of leukocytes. The second type of leukocytes may be type of leukocyte which is measured in a full blood count (CBC) test, for example, eosinophils or monocytes. The measured values may comprise, number of leukocytes, number of monocytes and number of eosinophils.

The infection status of a subject indicates whether an infection test (for example, an antigen or PCR test) has detected the infection in the subject.

The infection test for a subject may take place a period of time, Δt, after the time t_{b} at which the blood sample for that subject was taken. This period of time Δt allows for an infection that is, at the time of the blood sample t_{b}, present but not detectable by the infection test, to develop to a stage at which it is detectable by the infection test.

An infection test may comprise testing more than one sample from the subject. For example, an infection test may comprise testing a first sample taken at a first time after the blood sample and testing a second sample taken at a second time after the blood sample. If either the first or second sample test positive for the infection, the infection test result is positive. For infection with the virus SARS-CoV2, the period of time Δt may be between 7 and 14 days or may be 7 or 14 days. The first time may be 7 days and the second time may be 14 days. Additionally/alternatively, for infection with the virus SARS-CoV2, more than two infection test samples may be required and a repeating interval of time of Δt of approximately 3 days may be used for up to approximately 20 days.

Obtaining the infection status of the subjects may include receiving infection test results for the host and assigning an infection status. Alternatively, obtaining the infection status may comprise receiving the infection status. The status may be infected, meaning that the subject has the infection or uninfected, meaning that the subject does not have the infection according to an infection test result. The infection status or infection test results may be obtained from a server, a database, a user device, an infection testing device or a user input.

Analysing the measured values and infection statuses to determine a threshold value may comprise separating the measured values into an infected set and an uninfected set, where the infected set contains measured values for subjects with an infection status of infected and the uninfected set contains values measured values for subjects with an infection status of uninfected.

The analysis may further comprise comparing the measured values of the infected set and the uninfected set. Comparing the measured values of the infected set and the uninfected set may comprise performing a calculation on the measured values of each subject and comparing results of the calculation for measured values in the infected set with results of the calculation for measured values in the uninfected set. The calculations may be performed on the measured values before or after they are separated into an infected set or an uninfected set. Comparing results in the infected set with results in the uninfected set may comprise calculating a mean of the results for each set. Determining a threshold value may comprise selecting a value between the mean of the results for the infected set and the mean of the results in the uninfected set. An allowed range for the threshold value may be determined by the mean of the results for each set. A plurality of calculations and/or measured values may be used to determine a plurality of respective thresholds.

The calculation may be a calculation comparing the number of monocytes, M relative to the number of leukocytes, L. The calculation may be the ratio of number of monocytes to number of leukocytes, M/L=alpha, α. The calculation may be the number of leukocytes minus the number of monocytes, L−M=beta, β.

The calculation may be a calculation comparing the number of monocytes, M relative to the number of leukocytes, L and eosinophils, E. The calculation may be the ratio of number of monocytes to number of leukocytes plus the number of eosinophils, M/(L+E)=gamma, γ. The calculation may be the number of leukocytes plus the number of eosinophils minus the number of monocytes, L+E−M=delta, δ.

The measured values may comprise a number of leukocytes, number of eosinophils, number of neutrophils and number of lymphocytes. A calculation may be the number of leukocytes minus the number of neutrophils (λ=L−N). A calculation may be the number of leukocytes minus the number of eosinophils (κ=L−E). Comparing measured values with one or more stored thresholds may comprise comparing λ, κ and each of the measured values with a respective threshold.

The infection threshold μ (mu) for the κ calculation may be 7.00 10\hat{ }9/L. If the value is greater than μ (mu) then the result is positive. The infection threshold ν (nu) for the λ calculation may be 2.02 10\hat{ }9/L. If the value is less than that then the result is positive. The infection threshold ξ (xi) for number of eosinophils may be 0.09 10\hat{ }9/L. If the value is less than that then the result is positive. The infection threshold o (omicron) for number of lymphocytes may be 1.64 10\hat{ }9/L. If the value is less than that then the result is positive. The infection threshold ρ (ro) for number of neutrophils may be 5.07 10\hat{ }9/L. If the value is greater than that then the result is positive. The infection threshold σ (sigma) for number of leukocytes may be 8.00 10\hat{ }9/L. If the value is greater than that then the result is positive.

When one or more of the comparisons give a positive result, the determination that the host is infected may be made. Using the thresholds μ, ν, ξ, o, ρ and σ, the sensitivity may be 97.29% and the specificity may be 67.95%.

The infection threshold μ (mu) for the κ calculation may be between 3.50 10\hat{ }9/L to 10.50 10\hat{ }9/L, optionally, between 6.30 10\hat{ }9/L to 7.70 10\hat{ }9/L, optionally, 7.00 10\hat{ }9/L. If the value is greater than μ (mu) then the result is positive. The infection threshold ν (nu) for the λ calculation may be between 1.01 10\hat{ }9/L to 3.03 10\hat{ }9/L, optionally, between 1.818 10\hat{ }9/L to 2.222 10\hat{ }9/L, optionally, 2.02 10\hat{ }9/L. If the value is less than that then the result is positive. The infection threshold ξ (xi) for number of eosinophils may be between 0.045 10\hat{ }9/L to 0.135 10\hat{ }9/L, optionally, between 0.081 10\hat{ }9/L to 0.99 10\hat{ }9/L. optionally, 0.09 10\hat{ }9/L. If the value is less than that then the result is positive. The infection threshold o (omicron) for number of lymphocytes may be between 0.82 10\hat{ }9/L to 2.46 10\hat{ }9/L, optionally, between 1.476 10\hat{ }9/L to 1.804 10\hat{ }9/L, optionally, 1.64 10\hat{ }9/L. If the value is less than that then the result is positive. The infection threshold ρ (ro) for number of neutrophils may be between 2.535 10\hat{ }9/L to 7.605 10\hat{ }9/L, optionally, between 4.563 10\hat{ }9/L to 5.577 10\hat{ }9/L, optionally, 5.07 10\hat{ }9/L. If the value is greater than that then the result is positive. The infection threshold σ (sigma) for number of leukocytes may be between 4.00 10\hat{ }9/L to 12.00 10\hat{ }9/L, optionally, between 7.2 10\hat{ }9/L to 8.80 10\hat{ }9/L, optionally, 8.00 10\hat{ }9/L. If the value is greater than that then the result is positive.

When one or more of the comparisons give a positive result, the determination that the host is infected may be made. Using the thresholds μ, ν, ξ, o, ρ and σ, the sensitivity may be between 96.5% and 98.5%, optionally, 97.29% and the specificity may be between 66.00% to 69.00%, optionally, 67.95%.

A calculation may be the number of leukocytes minus the number of neutrophils (λ=L−N). Comparing measured values with one or more stored thresholds may comprise comparing each of λ, and the number of eosinophils and the number of lymphocytes with a respective threshold.

The infection threshold υ (upsilon) for the λ calculation may be 1.50 10\hat{ }9/L. If the value is less than that then the result is positive. The infection threshold φ (phi) for number of eosinophils may be 0.03 10\hat{ }9/L. If the value is less than that then the result is positive. The infection threshold χ (chi) for number of lymphocytes may be 1.10 10\hat{ }9/L. If the value is less than that then the result is positive.

When one or more of the comparisons give a positive result, the determination that the host is infected may be made. When the thresholds υ, φ and χ are used, the sensitivity of the determination of whether the host is infected may be 84.90% and the specificity may be 96.40%.

The infection threshold υ (upsilon) for the λ calculation may be between 0.75 10\hat{ }9/L to 2.25 10\hat{ }9/L, optionally, between 1.35 10\hat{ }9/L to 1.65 10\hat{ }9/L, optionally, 1.50 10\hat{ }9/L. If the value is less than that then the result is positive. The infection threshold φ (phi) for number of eosinophils may be 0.015 10\hat{ }9/L to 0.045 10\hat{ }9/L, optionally, between 0.027 10\hat{ }9/L to 0.033 10\hat{ }9/L, optionally, 0.03 10\hat{ }9/L. If the value is less than that then the result is positive. The infection threshold χ (chi) for number of lymphocytes may be between 0.55 10\hat{ }9/L to 1.65 10\hat{ }9/L, optionally, between 0.99 10\hat{ }9/L to 1.21 10\hat{ }9/L, optionally, 1.10 10\hat{ }9/L. If the value is less than that then the result is positive.

When one or more of the comparisons give a positive result, the determination that the host is infected may be made. When the thresholds υ, φ and χ are used, the sensitivity of the determination of whether the host is infected may be between 83% to 87%, optionally, 84.90% and the specificity may be between 95% to 98%, optionally, 96.40%.

For a given population and CBC testing conditions, comparison of one or more of these calculations will show statistically significant correlation of the calculation result with the SARS-CoV2 test result. Different calculations may also show statistically significant correlation of the calculation result with other types of infection. Other calculations may be used without departing from the method of the present invention.

The analysis may comprise performing more than one of the calculations on the measured values of each subject. The analysis may comprise obtaining a statistically significant correlation of a result of one of the calculations with the infection status and selecting that calculation. The analysis may further comprise calculating an infection threshold for the selected calculation. The infection threshold may be between a mean calculation result for the infected set and a mean calculation result for the uninfected set. The infection threshold may be calculated according to pre-set sensitivity and/or specificity parameters.

The analysis may comprise performing more than one of the calculations on the measured values of each subject and calculating an infection threshold for each calculation. In this way, more than one calculation and threshold may be used to determine if a host has an infection, thereby increasing the reliability of the determination.

The calculation(s) used may then be applied to measured values of a host in future as described above in the method of determining whether a host has an infection. The method of determining whether a host has an infection may be used on a regular basis for example for people who are likely to be exposed to the infection, for example health care workers and other key workers.

The calculations are then applied to standard full blood count (CBC) tests taken in future (if necessary on a regular basis) to identify which patients would test SARS-CoV2 positive (or negative) before symptoms occur, without performing the SARS-CoV2 test and at an earlier stage than the SARS-CoV2 test would have been able to identify the infection, because the difference between infected and non-infected people in calculation results α, β, γ and δ is typically apparent before symptoms occur, and before existing tests can distinguish between patients who would later test SARS-CoV2 positive and those who would test SARS-CoV2 negative.

For calculation β, where the data has been standardized, to have a mean of 0 and a standard deviation of 1, the infection threshold ζ (zeta) may be between −2.09 and −1.05, for example, −1.445. The infection threshold ζ (zeta) may be −1.445, when all age groups are taken together. This threshold distinguishes patients who will later test positive for SARS-CoV2 using the SARS-CoV-2 rt-PCR test. The value of ζ may be adjusted between −2.09 and −1.05 to adjust the ratio of false negatives to false positives in the test. In the test data sets initially used to determine this, p value is 1.2e-11.

ζ may be derived by separately determining the mean and standard deviation of β values of populations which have later gone on to be tested as either SARS-CoV2 positive or negative (having an infection status of infected or uninfected), creating two groups β+ and β−. ζ lies between the mean β value of the β+ set and the mean β value of the β− set. The proportion of false positives and false negatives and the sensitivity vs specificity can be adjusted by adjusting the exact positioning of (between the two populations β+ and β−.

θ can be derived by separately determining the mean and standard deviation of δ values of populations which have later gone on to be tested as either SARS-CoV2 positive or negative, creating two groups δ+ and δ−. θ lies between the mean δ value of the δ+ set and the mean δ value of the δ− set. The proportion of false positives and false negatives and the sensitivity vs specificity can be adjusted by adjusting the exact positioning of θ between the two populations δ+ and δ−.

Calculations for α, β, γ and δ may be made with standardized data and/or normalized data, and/or absolute data. Threshold numbers may be determined using standardized data and/or normalized data and/or absolute data.

Analysis may be wholly or partly performed using artificial intelligence. The selection of the calculation and/or selection of the threshold may be performed using artificial intelligence.

Statistical measures that indicate the proportions of false positives and false negatives that may be obtained for threshold values and may be used to determine an allowed range within which the threshold may be adjusted. In this way, the threshold values can be adjusted to adjust the balance of sensitivity vs specificity where increased sensitivity reduces false negatives and increased specificity reduces false positives.

There is also provided a method of adjusting a threshold value for use in determining whether a host has an infection, the method comprising: obtaining a threshold value and an allowed range for the threshold value and modifying the threshold value in response to a received sensitivity parameter, within the allowed range.

The threshold predictive and diagnostic values can be adjusted to adjust the balance of sensitivity vs specificity, according to how the test results will be used, taking into account the balance of health, social and economic consequences of false positives (which may lead to non-infected individuals having to isolate, and, where a subset of a population is tested, excessive restrictions on population interaction, with other health, social and economic consequences), and false negatives (which may lead to infectious individuals behaving as if non-infectious, and, where a subset of a population is tested, to inadequate restrictions on population interaction, causing the infection to spread further).

The threshold predictive and diagnostic values can be adjusted to adjust the balance of sensitivity vs specificity, according to how the test results will be used, taking into account the balance of health, social and economic consequences of false positives (which may lead to non-infected individuals having to isolate, and, where a subset of a population is tested, excessive restrictions on population interaction, with other health, social and economic consequences), and false negatives (which may lead to infectious individuals behaving as if non-infectious, and, where a subset of a population is tested, to inadequate restrictions on population interaction, causing the infection to spread further).

Further provided is a method of determining whether a host has an infection as described above, wherein the stored threshold value was calculated using a method of calculating a threshold value for use in determining whether a host has an infection described above. Further provided is a method of determining whether a host has an infection as described above, further comprising calculating the stored threshold value using the method of calculating a threshold value for use in determining whether a host has an infection described above.

The methods described above may be computer implemented methods. Obtaining data, such as measured values, blood test results, infection status, or any other data may comprise requesting said data from a server and/or cloud-based system and/or blood testing device and/or receiving the data from the server and/or cloud-based system. Analysis and/or calculations may be performed by a user device, or may be performed by a server and/or cloud-based system.

The threshold value and/or any calculations determined by the method of calculating a threshold value for use in determining whether a host has an infection may be stored on a server and/or cloud-based system and may be accessed by user devices, either periodically or prior to analysis of a host blood sample. In this way, the threshold and any calculations used on user devices in the method of determining whether a host has an infection may be kept up to date. Further, an entity such as a public health service may centrally adjust the threshold on the server to increase sensitivity or specificity of tests performed by user devices in the population. A series of threshold values and/or calculations may be stored, each of the threshold values and/or calculations being suitable for hosts/subjects with a respective factor or factors. In this way, the user device may select the threshold value and/or calculation from a series of threshold values based on one or more factors such as the age and/or sex of the host, genetic factors and/or environmental factors. Factors such as age and sex of the host may affect the threshold values and/or calculations which best distinguish between hosts with the infection and hosts who are not infected. By providing a series of calculations and/or thresholds to be selected from based on factors of the host, the result of the determination may be more accurate.

A further advantage to the methods of the present invention is that it can be quickly and inexpensively adapted to a new infection, thereby saving time at the beginning of a new outbreak. The method of calculating a threshold value for use in determining whether a host has the new infection can be performed on a sample of the population and then the threshold and any calculations determined by this method can be immediately utilised in the method of determining whether a host has an infection described above. This may be much quicker to develop and implement than a new diagnostic test which may require reagents to be produced and distributed,

Further provided is a system configured to carry out a method as described above. The system may comprise a user device, such as a laptop, smartphone, tablet and/or blood testing device, and/or a server, and/or a cloud-based system. The system may comprise a user device configured to carry out the method described above of determining whether a host has an infection, wherein the user device is configured to obtain measured values comprising a number of leukocytes and a number of a first type of leukocytes in a blood sample from the host and compare the measured values with one or more stored threshold value(s) to determine whether the host has said infection. The system may further comprise a server or cloud-based system is configured to store the stored threshold value(s). The user device may be configured to obtain the stored threshold value(s) from the server or cloud-based system. Further possible features of the system have been described above in relation to method steps which may be carried out by devices.

There is further provided a computer-readable medium having computer-executable instructions adapted to carry out the method described above of calculating a threshold value for use in determining whether a host has an infection and/or the method described above of determining whether a host has an infection.

Further features and advantages of the above described aspects of the present disclosure will become apparent from the claims and the following description.

### BRIEF DESCRIPTION OF DRAWINGS

Embodiments of the present disclosure will now be described by way of example only, with reference to the following diagrams, in which:—

FIG. 1 is a flow chart outlining a method of determining threshold values for a specific infection;

FIG. 2 is a flow chart outlining a method of using the threshold value determined in the flow chart of FIG. 1 to determine if a host has the infection.

### DETAILED DESCRIPTION

In general terms embodiments of the invention relate to the use of measured values comprising a number of leukocytes and a number of a type of leukocytes in a blood sample of a host to determine whether the host has a particular infection. The examples discussed below concern an implementation of such a method to determine whether a host has an infection with the virus SARS-CoV2 which causes the illness Covid-19, however, it will be understood that the invention is not limited to this infection.

The method described below for determining threshold values for a specific infection and using those threshold values to make a diagnosis of that infection in a patient beneficially allows a diagnosis of a specific infection to be made earlier in the infection's lifecycle than the current available methods for detecting infections.

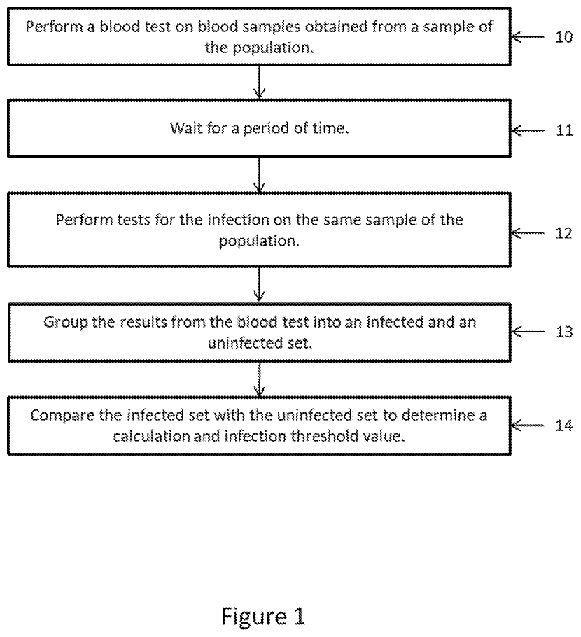

To place embodiments of the invention in a suitable context reference will now be made to FIG. 1 which shows a flow chart outlining a method of determining threshold values for a specific infection, in this case, infection by the virus SARS-CoV2. In Step 10, a full blood count test is conducted on blood samples obtained from a sample of the population. The sample contains at least some people who are likely to have been exposed to SARS-CoV2. Further subjects may be added to the sample over time as more subjects are tested, thereby increasing the size of the data set to be analysed. Increasing the sample size may allow for more accurate threshold values to be determined.

Step 11 shows that there is a period of time between blood samples being taken from the subjects and tests for the infection being performed on the subjects in Step 12. This is important as it allows time for the infection to develop to detectable levels in the subjects. As discussed above, one of the advantages of the methods described herein is that the infection can be detected before currently available infection tests. So, the waiting time signified by Step 11 allows comparison of the present method at an early stage of infection with currently available tests at a time when the infection can be detected by the available tests.

In some embodiments, more than one infection test may be performed at different times to each other, to ensure that any infection that develops in a subject is detected by an infection test. The blood samples for the CBC may be collected, for example 7 days before a first infection test and 14 days before a second infection test to allow sufficient time for the infection to become detectable by at least one of the diagnostic tests.

In Step 12, diagnostic tests for the infection being targeted are carried out on the same sample of the population as Step 10. The diagnostic infection test performed may be the current‘gold standard’ diagnostic test for the specific infection being targeted. For example, if the targeted infection is the virus SARS-CoV2 which causes the illness Covid-19, the relevant ‘gold standard’ diagnostic test may be a PCR test.

In Step 13, the full blood count test results are separated into an infected and uninfected set based on whether the diagnostic infection tests returned an infected or uninfected result for the subject.

In Step 14, the infected set is compared with the uninfected set to determine a calculation and infection threshold value. The calculation and associated threshold value is chosen to best separate the infected and uninfected sets, so that the calculation and threshold can be used later to determine whether a host has an infection from their blood test results alone, without the need for an infection test.

Calculations are performed on the full blood count test results to determine values, such as ratios and differences, between the types of white blood cell. The method analyses only a selection of the results given by the full blood count. In this example, from the full blood count results, the number of leukocytes, number of monocytes and number of eosinophils were analysed for each subject. A plurality of calculations may be performed on each of the subjects' results, and the calculation which best separates the infected and uninfected sets may be selected.

Step 13 of grouping the test results into an infected set and an uninfected set may be done before or after the calculations are performed.

In this example, two different calculations are performed using only the number of monocytes and leukocytes from the full blood count tests. The first calculation is to determine the ratio (a, alpha) between the number of monocytes and leukocytes (monocytes/leukocytes). The second calculation is to determine the difference (P, beta) between the number of leukocytes and the number of monocytes (leukocytes−monocytes).

Two further calculations are performed using the number of monocytes, leukocytes and eosinophils from the full blood count tests. The first calculation is to determine the ratio (γ, gamma) between the number of monocytes and the number of leukocytes plus the number of eosinophils (monocytes/(leukocytes+eosinophils)). The second calculation is to determine the net difference (δ, delta) between the number of leukocytes plus eosinophils and the number of monocytes (leukocytes+eosinophils−monocytes).

The above calculations all show statistically significant correlations between the calculation and the infection status (infected or uninfected). From these correlations, a threshold value for each calculation (δ, γ, β, α) can be determined.

Statistical measures may also be determined to indicate the proportion of false positives and false negatives that may be obtained from the threshold values. The threshold values may be adjusted according to how the test results will be used. For example, the specificity and sensitivity of the test can be altered to take into account the balance of health, social and economic consequences of false positives and false negatives.

A threshold value (ζ, zeta) which distinguishes between subjects who will later go on to test positive for the infection being targeted using the full set of diagnostic tests is determined for the β calculation. The threshold value (ζ, zeta) may be determined by standardizing the data for β to have a mean of 0 and a standard deviation of 1. The infection threshold ζ (zeta) in this example is −1. The threshold value (ζ, zeta) may be adjusted to alter the proportion of false positives and negatives in the full blood count test results. The threshold value (ζ, zeta) may be derived by calculating the mean and standard deviation for each of the infected set, β+ and uninfected set, β−. The threshold value (ζ, zeta) lies between the mean value of the β+set and the β− set. Adjusting the threshold value (ζ, zeta) between the β+ set and the β− set may alter the proportion of false positives and negatives when using the threshold to determine infection.

A threshold value (θ, theta) which distinguishes patients who will later go on to test positive for the specific infection being targeted using the full set of diagnostic tests may be determined for the δ calculation. The threshold value (θ, theta) may be determined by standardizing the data for δ to have a mean of 0 and a standard deviation of 1. The infection threshold (θ, theta) in this example is −1. Adjusting the threshold value (θ, theta) may alter the proportion of false positives and negatives in the full blood count test results. The threshold value (θ, theta) may be derived by calculating the mean and standard deviation for the two δ groups (patients who have gone on to test positive for the targeted infection and those who have gone on to test negative), creating two new groups δ+ and δ. The threshold value (θ, theta) lies between the mean value of the δ+ set and the δ− set. Adjusting the threshold value (θ, theta) between the δ+ set and the δ− set may alter the proportion of false positives and negatives when using the threshold to determine infection.

A threshold value (ε, epsilon) which distinguishes patients who will later go on to test positive for the specific infection being targeted using the full set of diagnostic tests may be determined for the α calculations. The threshold value (ε, epsilon) may be determined by standardizing the data for α to have a mean of 0 and a standard deviation of 1. Adjusting the threshold value (ε, epsilon) may alter the proportion of false positives and negatives in the full blood count test results. The threshold value (ε, epsilon) may be derived by calculating the mean and standard deviation for the two α groups (patients who have gone on to test positive for the targeted infection and those who have gone on to test negative), creating two new groups α+ and α−. The threshold value (ε, epsilon) lies between the mean value of the α+ set and the α− set. Adjusting the threshold value (ε, epsilon) between the α+ set and the α− set may alter the proportion of false positives and negatives when using the threshold to determine infection.

A threshold value (η, eta) which distinguishes patients who will later go on to test positive for the specific infection being targeted using the full set of diagnostic tests may be determined for the γ calculations. The threshold value (η, eta) may be determined by standardizing the data for α to have a mean of 0 and a standard deviation of 1. Adjusting the threshold value (η, eta) may alter the proportion of false positives and negatives in the full blood count test results. The threshold value (η, eta) may be derived by calculating the mean and standard deviation for the two α groups (patients who have gone on to test positive for the targeted infection and those who have gone on to test negative), creating two new groups γ+ and γ−. The threshold value (η, eta) lies between the mean value of the γ+ set and the γ− set. Adjusting the threshold value (η, eta) between the means of the γ+ set and the γ− set may alter the proportion of false positives and negatives when using the threshold to determine infection.

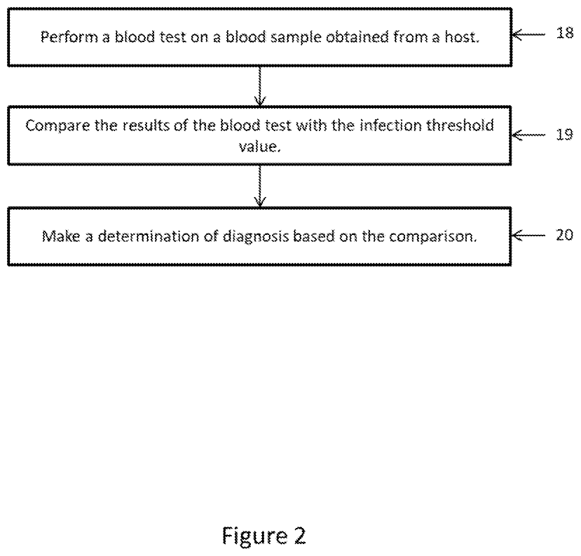

FIG. 2 shows a method of determining if a host has an infection using the determined threshold(s) along with results of a CBC test on a blood sample from the host.

In Step 18, a full blood count test is performed on a blood sample obtained from a host (in this case, a patient who may be infected with SARS-CoV2). Measured values including number of leukocytes, number of monocytes and number of eosinophils are extracted from the CBC test results. In other embodiments, another type of blood test including these measured values may be used in place of a CBC test.

The four calculations (δ, γ, β, α) are made on the measured values and compared to the threshold values θ, η, ζ, ε. In other embodiments, less than four, for example only one calculation may be made and compared with the calculation's associated threshold.

In Step 20, a determination of diagnosis is made based on the comparison of the result of the calculation on the patient's measured values with the associated threshold value. If the result of the calculation on the patient's measured values is on the infected sied of the threshold, then the patient is determined to be infected, but if the result of the calculation on the patient's measured values is on the uninfected side of the threshold, then the patient is determined to be uninfected. For example, where the mean of the uninfected set is greater than the threshold, the patient will be determined to be uninfected if the result of the calculation on the patient's measured values is also greater than the threshold.

A second example will now be described and is the same as the example described above in relation to FIGS. 1 and 2 with the changes described below.

In the second example, different measured values are taken from the full blood count results and different set of calculations are performed. At step 14, from the full blood count results, the number of leukocytes, number of neutrophils, number of eosinophils and number of lymphocytes were analysed for each subject. Two calculations were performed on each of the subjects' results. The first calculation is the number of leukocytes minus the number of eosinophils (κ=L−E) and the second is the number of leukocytes minus the number of neutrophils (λ=L−N).

Threshold values which distinguish patients who will later go on to test positive for the specific infection being targeted using the full set of diagnostic tests is determined for each calculation and for each of the number of leukocytes, number of eosinophils, number of neutrophils and number of lymphocytes. The threshold values may be determined by standardizing the data for each calculation to have a mean of 0 and a standard deviation of 1. The threshold values may be derived by calculating the mean and standard deviation for the two groups (patients who have gone on to test positive for the targeted infection and those who have gone on to test negative), creating two new groups of infected and uninfected results. The threshold value lies between the mean value of the infected set and the uninfected set. Adjusting the threshold values between the means of the infected set and the uninfected set may alter the proportion of false positives and negatives when using the threshold to determine infection.

In Step 18, a full blood count test is performed on a blood sample obtained from a host (in this case, a patient who may be infected with SARS-CoV2). Measured values including number of leukocytes, number of neutrophils, number of lymphocytes and number of eosinophils are extracted from the CBC test results. In other embodiments, another type of blood test including these measured values may be used in place of a CBC test.

The two calculations (κ=L−E and λ=L−N) are made on the measured values and the calculation results and the measured values are compared to the threshold values.

The infection threshold μ (mu) for the κ calculation is 7.00 10\hat{ }9/L. If the value is greater than μ (mu) then the result of the comparison is positive. The infection threshold ν (nu) for the λ calculation is 2.02 10\hat{ }9/L. If the value is less than that then the result of the comparison is positive. The infection threshold ξ (xi) for number of eosinophils is 0.09 10\hat{ }9/L. If the value is less than that then the result of the comparison is positive. The infection threshold o (omicron) for number of lymphocytes is 1.64 10\hat{ }9/L. If the value is less than that then the result of the comparison is positive. The infection threshold ρ (ro) for number of neutrophils is 5.07 10\hat{ }9/L. If the value is greater than that then the result of the comparison is positive. The infection threshold σ (sigma) for number of leukocytes is 8.00 10\hat{ }9/L. If the value is greater than that then the result of the comparison is positive.

When one or more of the comparisons give a positive result, the determination that the host is infected is made. Using the thresholds μ, ν, ξ, o, ρ and σ, the sensitivity is 97.29% and the specificity may be 67.95%.

In Step 20, a determination of diagnosis is made based on the comparisons of the calculation results and measured values with the respective threshold values. If any of the comparison results determine that the patient is infected, then the patient may be determined to be infected.

A third example will now be described and is the same as the example described above in relation to FIGS. 1 and 2 with the changes described below.

In the third example, different measured values are taken from the full blood count results and different set of calculations are performed. At step 14, from the full blood count results, the number of leukocytes, number of neutrophils, number of eosinophils and number of lymphocytes were analysed for each subject. One calculation was performed on each of the subjects' results. The calculation is the number of leukocytes minus the number of neutrophils (λ=L−N).

Threshold values which distinguish patients who will later go on to test positive for the specific infection being targeted using the full set of diagnostic tests is determined for the calculation and for the number of eosinophils and number of lymphocytes. The threshold values may be derived by calculating the mean and standard deviation for the two groups (patients who have gone on to test positive for the targeted infection and those who have gone on to test negative), creating two new groups of infected and uninfected results. The threshold value lies between the mean value of the infected set and the uninfected set. Adjusting the threshold values between the means of the infected set and the uninfected set may alter the proportion of false positives and negatives when using the threshold to determine infection.

Alternatively, the threshold values may be determined by standardizing the data for each calculation to have a mean of 0 and a standard deviation of 1.

In Step 18, a full blood count test is performed on a blood sample obtained from a host (in this case, a patient who may be infected with SARS-CoV2). Measured values including number of leukocytes, number of neutrophils, number of lymphocytes and number of eosinophils are extracted from the CBC test results. In other embodiments, another type of blood test including these measured values may be used in place of a CBC test.

The calculation (λ=L−N) is made on the measured values and the calculation results and the measured values are compared to the threshold values.

The infection threshold υ (upsilon) for the λ calculation is 1.50 10\hat{ }9/L. If the value is less than that then the result of the comparison is positive. The infection threshold φ (phi) for number of eosinophils is 0.03 10\hat{ }9/L. If the value is less than that then the result of the comparison is positive. The infection threshold χ (chi) for number of lymphocytes is 1.10 10\hat{ }9/L. If the value is less than that then the result of the comparison is positive.

When one or more of the comparisons give a positive result, the determination that the host is infected may be made. When the thresholds υ, φ and χ are used, the sensitivity of the determination of whether the host is infected is 84.90% and the specificity is 96.40%.

In Step 20, a determination of diagnosis is made based on the comparisons of the calculation results and measured values with the respective threshold values. If any of the comparison results determine that the patient is infected, then the patient may be determined to be infected.

Although particular embodiments of the disclosure have been disclosed herein in detail, this has been done by way of example and for the purposes of illustration only. The aforementioned embodiments are not intended to be limiting with respect to the scope of the statements of invention and appended claims.

It is contemplated by the inventors that various substitutions, alterations, and modifications may be made to the invention without departing from the scope of the invention as defined by the statements of invention and claims.

1. A method of determining whether a host has an infection, the method comprising:
obtaining measured values comprising a number of leukocytes and a number of a first type of leukocytes in a blood sample from the host, and
comparing the measured values with one or more stored threshold value(s) to determine whether the host has said infection.

2. A method according to claim 1, wherein the infection is infection by the virus SARS-CoV2.

3. A method according to claim 1, wherein comparing the measured values with one or more stored threshold value(s) to determine whether the host has the infection comprises performing at least one calculation on the measured values and comparing the result of the calculation(s) with a respective one of the threshold value(s).

4. A method according to claim 1, wherein the first type of leukocytes is neutrophils.

5. A method according to claim 3, wherein one of the at least one calculation(s) is λ, λ being the number of leukocytes, L, minus the number of neutrophils, N.

6. A method according to claim 1, wherein the measured values further comprise a number of eosinophils.

7. A method according to claim 3, wherein one of the at least one calculation(s) is κ, κ being the number of leukocytes, L, minus the number of eosinophils, E.

8. A method according to claim 1, wherein the measured values further comprise a number of lymphocytes.

9. A method according to claim 1, wherein comparing measured values with one or more stored threshold values(s) comprises comparing each of λ, κ, the number of leukocytes, the number of neutrophils, the number of eosinophils and the number of lymphocytes with a respective threshold.

10. A method according to claim 9,
wherein the respective threshold for the calculation λ is ν (nu)=2.02 10\hat{ }9/L, wherein when the result of λ is less than ν (nu) then a result of a comparison for λ is positive, and/or wherein the respective threshold for the calculation κ is μ (mu)=7.00 10\hat{ }9/L, wherein when the result of κ is greater than μ (mu) then a result of a comparison for κ is positive, and/or wherein the respective threshold for the number of eosinophils is ξ (xi)=0.09 10\hat{ }9/L, wherein when the number of eosinophils is less than ξ (xi) then a result of a comparison for the number of eosinophils is positive, and/or
wherein the respective threshold for the number of lymphocytes is o (omicron)=1.64 10\hat{ }9/L,
wherein when the number of lymphocytes is less than o (omicron) then a result of a comparison for the number of lymphocytes is positive, and/or
wherein the respective threshold for the number of neutrophils is ρ (ro)=5.07 10\hat{ }9/L, wherein when the number of neutrophils is greater than ρ (ro) then a result of a comparison for the number of neutrophils is positive, and/or
wherein the respective threshold for the number of leukocytes is σ (sigma)=8.00 10\hat{ }9/L,
wherein when the number of neutrophils is greater than σ (sigma) then a result of a comparison for the number of leukocytes is positive.

11. A method according to claim 1 and wherein the measured values further comprise a number of lymphocytes, wherein comparing measured values with one or more stored threshold values(s) comprises comparing each of λ, the number of eosinophils and the number of lymphocytes with a respective threshold.

12. A method according to claim 11,
wherein the respective threshold for the calculation λ is υ (upsilon)=1.50 10\hat{ }9/L, wherein when the result of λ is less than υ (upsilon) then a result of a comparison for λ is positive, and/or wherein the respective threshold for the number of eosinophils is ϕ (phi)=0.03 10\hat{ }9/L and when the number of eosinophils is less than ϕ (phi) then a result of a comparison for number of eosinophils is positive, and/or
wherein the respective threshold for the number of lymphocytes is χ (chi)=1.10 10\hat{ }9/L and
when the number of lymphocytes is less than χ (chi) then a result of a comparison for the number of lymphocytes is positive.

13. A method according to claim 10, wherein when the result of at least one of the comparisons is positive, comparing the measured values with one or more stored threshold value(s) determines that the host has said infection.

14. A method of calculating a threshold value for use in determining whether a host has an infection, the method comprising:
obtaining measured values comprising a number of leukocytes and a number of a first type of leukocytes in a blood sample from each of a plurality of subjects,
obtaining an infection status for each of the subjects,
analysing the measured values and infection statuses to determine the threshold value.

15. A method according to claim 14, wherein analysing the measured values and infection statuses to determine a threshold value comprises separating the measured values into an infected set and an uninfected set, wherein the infected set contains measured values for subjects with an infection status of infected and the uninfected set contains values measured values for subjects with an infection status of uninfected.

16. A method according to claim 15, wherein the analysis further comprises performing a calculation on the measured values of each subject and comparing results of the calculation for measured values in the infected set with results of the calculation for measured values in the uninfected set.

17. A method according to claim 16, wherein comparing results in the infected set with results in the uninfected set comprises calculating a mean of the results for each set and determining a threshold value comprises selecting a value between the mean of the results for the infected set and the mean of the results in the uninfected set.

18. A method according to claim 14, wherein the first type of leukocytes is neutrophils.

19. A method according to claim 18, when dependent on claim 16 wherein the calculation is the number of leukocytes minus the number of neutrophils L−N=λ.

20. A method according to claim 14, wherein the first type of leukocytes is eosinophils.

21. A method according to claim 20, wherein the calculation is the number of leukocytes minus the number of eosinophils L−E=κ.

22. A method of adjusting the threshold value determined using a method of claim 14, the method comprising:
obtaining the threshold value and an allowed range for the threshold value and
modifying the threshold value in response to a received sensitivity parameter, within the allowed range.

23. A method of determining whether a host has an infection according to claim 1, wherein the one or more stored threshold value(s) are calculated using a method of calculating a threshold value for use in determining whether a host has an infection.

24. A system configured to carry out a method according to claim 1, wherein the system comprises:
a user device and a server,
wherein the user device is configured to obtain the measured values and compare the measured values with a respective one of the stored threshold value(s) to determine whether the host has said infection,
wherein the server is configured to store the stored threshold value(s) and
wherein the user device is configured to obtain the stored threshold value(s) from the server.
